(19) United States
(12) Patent Application Publication
(10) Pub. No.: US 2019/0275862 A1
(43) Pub. Date: Sep. 12, 2019

(54) VEHICLE HEATING SYSTEM

(71) Applicant: Eberspächer Climate Control Systems GmbH & Co. KG, Esslingen (DE)

(72) Inventors: Maximilian PEITZ, Kirchheim unter Teck (DE); Frank BARTHEL, Tiefenbronn (DE); Oliver ROPPELT, Deizisau (DE); Hans JENSEN, Dettingen unter Teck (DE)

(21) Appl. No.: 16/296,794

(22) Filed: Mar. 8, 2019

(30) Foreign Application Priority Data
Mar. 12, 2018 (DE) 10 2018 105 585.4
Mar. 27, 2018 (DE) 10 2018 107 216.3

(51) Int. Cl. B60H 1/22

(52) U.S. Cl. CPC B60H 1/2206; B60H 1/2212; B60H 2001/2231; B60H 2001/2284; B60H 2001/2253; B60H 2001/2259; B60H 2001/2281; B60H 2001/224

(57) ABSTRACT

A vehicle heating system includes a fuel-operated heater (16) with a burner area (18), with a combustion air blower (20) for feeding combustion air to the burner area (18). A fuel pump (26) feeds fuel to the burner area (18). An actuating device (40) actuates the combustion air blower (20) and the fuel pump (26). The actuating device (40) is configured to actuate the combustion air blower (20) and the fuel pump (26) to carry out a fording operation upon receipt of a fording state information.

### CROSS REFERENCE TO RELATED APPLICATIONS

This application claims the benefit of priority under 35 U.S.C. § 119 of German Applications 10 2018 105 585.4, filed Mar. 12, 2018 and 10 2018 107 216.3, filed Mar. 27, 2018, the entire contents of which are incorporated herein by reference.

### TECHNICAL FIELD

The present invention pertains to a vehicle heating system, comprising a fuel-operated heater with a burner area, with a combustion air blower for feeding combustion air to the burner area, with a fuel pump for feeding fuel to the burner area and with an actuating device for actuating the combustion air blower and the fuel pump, as well as to a process for operating such a vehicle heating system.

### BACKGROUND

It cannot be ruled out, for example, in case of off-road vehicles that these are operated during some phases in a fording state, i.e., in a state in which the vehicle is moved in water and thus there is, in principle, a risk that water will enter via openings different system areas of a vehicle and damage them. Such a state may also occur in conventional vehicles, for example, in case of flooded streets or when picking up a boat on a boat trailer.

### SUMMARY

An object of the present invention is to provide a vehicle heating system and a process for operating a vehicle heating system, with which damage to the vehicle heating system, which is caused by a fording state, is avoided.

According to one aspect of the present invention, this object is accomplished by a vehicle heating system comprising a fuel-operated heater with a burner area, with a combustion air blower for feeding combustion air to the burner area, with a fuel pump for feeding fuel to the burner area and with an actuating device for actuating the combustion air blower and the fuel pump, wherein the actuating device is configured to actuate the combustion air blower and the fuel pump to carry out a fording operation upon receipt of fording state information.

Steps are taken in the vehicle heating system according to the present invention to protect the heater from the entry of water when a fording state or the risk of occurrence of a fording state occurs.

These steps may provide, for example, for the actuating device to be configured to actuate the combustion air blower for operation at a fording operation speed or/and at a fording operation feed rate and to put the fuel pump out of operation or/and to keep the fuel pump out of operation in order to carry out the fording operation. A back pressure, preventing the entry of water via an exhaust system or via a waste gas outlet area of the heater, is built up by the air pressure generated by feeding combustion air or air. Since the fuel pump is deactivated or remains deactivated, the escape of unburned fuel is prevented. The above explanations show that the carrying out of a fording operation or the corresponding actuation of the combustion air blower and of the fuel pump may also comprise a state in which the fuel pump, which was not being operated before when the heater was deactivated, continues to be out of operation. This keeping of the fuel pump out of operation also represents an actuation of the fuel pump in the sense of the present invention in the context of the fording operation.

To provide the information showing an existing fording state or a planned fording state, at least one fording state information generation device may be provided for generating and entering the fording state information into the actuating device. For example, the fording state generation device may comprise at least one fording state sensor.

At least one fording state sensor may comprise a water level sensor for a reliable detection of a fording state. At least one water level sensor may be arranged in the area of a waste gas outlet area of an exhaust system associated with the heater. As an alternative or in addition, such a water level sensor may be arranged at the front area or/and at the rear area of a vehicle.

At least one fording state sensor may comprise a temperature sensor in another type of configuration. Such a temperature sensor, configured, for example, as a flame sensor of the heater, may be arranged in the area of a waste gas outlet area of the heater or/and in the area of an exhaust gas outlet of an exhaust system of the heater.

If the fording state information generation device comprises at least one fording state switch, which can be actuated by a human operator, a human operator, i.e., for example, the driver of a vehicle, may be given the possibility of preparing the vehicle heating system for this state already before the occurrence of a fording state.

Further, the fording state information generation device may comprise a vehicle control device, which feeds fording state information into a vehicle data bus system. The vehicle control device may generate this information on the basis of, for example, sensors feeding sensor signals into this vehicle control device, which sensors can then also act as fording state sensors in the sense of the present invention. An actuating device of the heater can capture this information from the vehicle data bus system and put the heater into a fording operation if necessary.

According to another aspect, the object is accomplished by a process for operating a vehicle heating system, preferably a vehicle heating system configured according to the present invention, said vehicle heating system comprising a fuel-operated heater with a burner area, with a combustion air blower for feeding combustion air to the burner area, with a fuel pump for feeding fuel to the burner area and with an actuating device for actuating the combustion air blower and the fuel pump, comprising the steps of
a) generating fording state information indicating an existing or planned fording state of the vehicle and entering the fording state information into the actuating device, and
b) actuating the combustion air blower and the fuel pump to carry out a fording operation after receipt or/and processing of the fording state information in the actuating device.

The combustion air blower may be operated during step b) at a fording operation speed or/and at a fording operation feed rate, for example, at a maximum possible speed, and the fuel pump may be put out of operation or/and kept out of operation in order to avoid the release of unburned fuel to the outside.

The fording state information may be generated in step a) by actuating a fording state switch.

To increase the operational reliability, provisions may be made for the fording state information being generated in step a) by at least one water level sensor detecting a water level in the area of a vehicle.

In a variant that can be embodied in a structurally simple manner, the fording state information may be generated in step a) by a flame sensor of the heater, which flame sensor is configured as a temperature sensor. For example, the change over time of an output signal reflecting a temperature in the area of the flame sensor may be analyzed for this such that the presence of a fording state is detected when a gradient of the output signal drops below a predefined negative threshold value.

The present invention further pertains to a vehicle comprising a vehicle heating system having the configuration according to the present invention, which is preferably operated with a process according to the present invention.

Provisions are preferably made in such a vehicle for a combustion air inlet area of the combustion air blower to be arranged in a vertical direction above a waste gas outlet area of the burner area or/and above an exhaust gas outlet area of an exhaust system associated with the heater. The entry of water via the combustion air inlet area can thus be prevented.

The various features of novelty which characterize the invention are pointed out with particularity in the claims annexed to and forming a part of this disclosure. For a better understanding of the invention, its operating advantages and specific objects attained by its uses, reference is made to the accompanying drawing and descriptive matter in which preferred embodiments of the invention are illustrated.

### BRIEF DESCRIPTION OF THE DRAWING

In the drawing:

FIG. 1 is a schematic diagram showing a vehicle equipped with a vehicle heating system.

### DESCRIPTION OF PREFERRED EMBODIMENTS

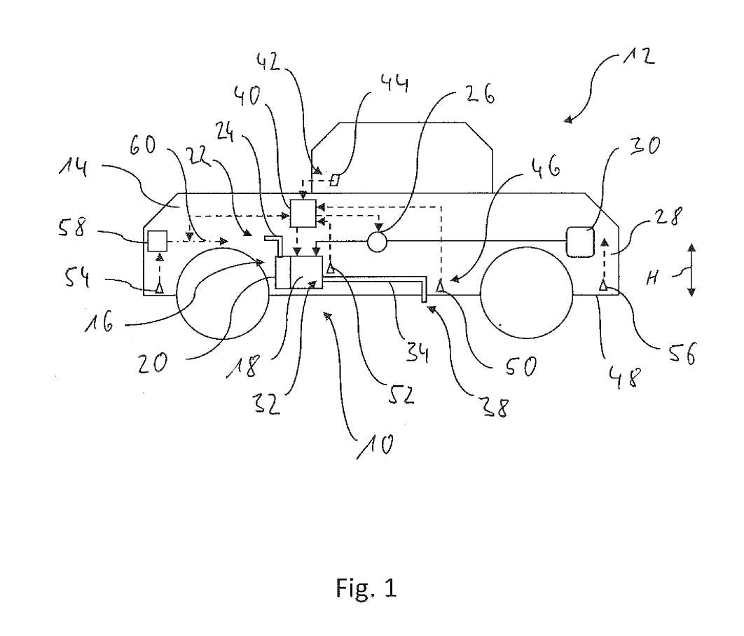

Referring to the drawing, a vehicle equipped with a vehicle heating system 10 is generally designated by 12 in FIG. 1. The vehicle heating system 10 comprises a fuel-operated heater 16 arranged, for example, in or close to an engine compartment provided in a front area 14 of the vehicle 12. The heater 16 comprises a burner area 18 with a combustion chamber formed in the burner area 18 and with a heat exchanger area, in which the heat of combustion generated in the heater 16 can be transferred to a medium to be heated, for example, the air to be introduced into a vehicle interior. The heater 16 further comprises a combustion air blower 20, by which the combustion air necessary for the combustion can be fed into the burner area 18. The combustion air blower 20 comprises a combustion air inlet area 22, which may be provided, for example, directly at a housing of the combustion air blower 20 or at a combustion air guide area 24 leading away therefrom.

The fuel necessary for the combustion with the combustion air is fed into the burner area 18 by a fuel pump 26 from a tank 30 positioned, for example, in or close to a rear area 28 of the vehicle 12.

The mixture of combustion air and fuel, which is formed in the combustion chamber of the burner area 18, is burned and the combustion waste gases generated in the process leave the heater 16 via a waste gas outlet area 32 or an exhaust system 34 arranged downstream of this. The exhaust system 34 may comprise, for example, a muffler or/and an exhaust gas purification device and the exhaust system 34 releases the waste gas discharged from the burner area 18 to the environment via an exhaust gas outlet area 38.

The vehicle heating system 10 comprises, in association with the heater 16, an actuating device 40, which may also be integrated, for example, into the heater 16. The actuating device 40 comprises one or more processors and associated memory. This actuating device 40 is configured to control the operation of the heater 16 by actuating especially the combustion air blower 20 and the fuel pump 26 and to regulate the combustion air blower 20 and the fuel pump 26 on the basis of feedback information. In particular, the actuating device 40 may be configured to operate the combustion air blower 20 at a speed or feed rate necessary for a certain heating operation by applying a suitable voltage. To introduce the quantity of fuel necessary for a desired combustion operation, the actuating device 40 may be configured to actuate the fuel pump 26, which may be configured, for example, as a feed pump with a reciprocating piston, such that the fuel pump 26 operates at a corresponding cycle frequency for feeding the necessary quantity of fuel.

If such a vehicle 12 is operated in a fording state, i.e., in a state, in which especially the lower area of the vehicle 12 is moved in water or stands in water and thus there is a potential risk that water could enter the heater 16 via the exhaust system 34 and damage this, the vehicle heating system 10 is put into a state in which it operates in a fording operation.

It is necessary for this fording operation first to provide information by a fording state information generation device generally designated by 42 and to enter this information into the actuating device 40, so that the actuating device 40 can take steps protecting the heater 16.

The fording state information generation device 42 may comprise, for example, a fording state switch 44. This may be accommodated in the area of a dashboard of the vehicle 12 and the fording state switch 44 gives the driver of the vehicle 12 the possibility of generating fording state information by actuating the fording state switch 44, and this fording state information is entered into the actuating device 40. Based on this fording state information, the actuating device 40 actuates the heater 16 to change over into the fording operation such that the combustion air blower 20 is operated, for example, at a speed or feed rate predefined for the fording operation. This speed may correspond, for example, to a very high speed or to a speed that is the maximum possible speed for the combustion air blower 20 or for a feed wheel driven by an electric motor, in order to feed the maximum possible quantity of air into the burner area 18 and via this into the exhaust system 34. The actuating device 40 may be configured for this, for example, to apply an operating voltage with a duty factor predefined for the fording operation to the electric motor of the combustion air blower 20.

In case of a changeover to the fording operation, the actuating device 40 actuates the fuel pump 26 such that if it was put into operation before for carrying out a combustion operation of the heater 16, it is put out of operation and the feeding of fuel into the burner area 18 is thus stopped. If the fuel pump 26 had not been in operation before the fording state information was received, which means that the heater 16 was likewise not being operated in the heating mode, the fuel pump 26 is kept by the actuating device 40 out of operation for the fording operation or during the fording operation, which ultimately means that no actuating signal that would put the fuel pump 26 into operation is sent to the fuel pump.

Due to the feeding of fuel into the burner area 18 being stopped or prevented during the fording operation, it is ensured that no unburned fuel is released during the fording operation into the exhaust system 34 and via this into the environment. Since combustion would not be possible in the burner area 18 under proper conditions or combustion would stop when a fording state occurs and, for example, water slightly enters via the exhaust system 34 due to the rising back pressure, it is actively ensured at the time of a changeover into the fording operation that the combustion is ended in a defined manner.

By actuating the fording state switch 44, the driver of the vehicle 12 can put the vehicle heating system 10 or the heater 16 thereof anticipatorily into the fording operation already when the risk of a fording operation can be detected or a fording operation shall be brought about intentionally. After ending the fording operation, the generation of the fording state information can be ended by repeatedly actuating the fording state switch 44, or information, which shows to the actuating device 40 that the fording state is ended and the normal operation of the heater 16 can again be resumed, if necessary, can be generated.

In order to make it possible to provide information that indicates the occurrence or the presence of a fording state as an alternative or in addition to the generation of the fording state information by the fording state switch 44 of the actuating device 40, the fording state information generation device 42 may comprise at least one fording state sensor generally designated by 46. This sensor 46 may comprise, for example, a water level sensor 50 arranged close to the exhaust gas outlet area 38, i.e., also close to an underbody 48 of the vehicle 12. The water level sensor 50 may be configured, for example, to indicate a water level reaching the water level sensor 50 and accordingly to enter fording state information into the actuating device 40. For example, the water level sensor 50 may be configured for this as a water sensor or with a float, which closes or interrupts an electrical contact when a correspondingly high water level develops. It is also possible, in principle, to configure such a water level sensor as a temperature sensor. The actuating device 40 can also take the above-operated steps to put the heater 16 into the fording operation when the fording state information is generated in this manner, i.e., when it is detected by means of a sensor.

As an alternative or in addition, a flame sensor 52, which is associated with the heater 16 and is configured as a temperature sensor, may be used as a fording state sensor 46 in order to enter information corresponding to the occurrence of a fording state into the actuating device 40. Such a flame sensor may be positioned at the heater 16, for example, close to the waste gas outlet area 32 of the burner area 18 or close to the exhaust gas outlet area 38 of the exhaust system 34 in order to make it possible, in principle, to infer the quality or the presence of a state of combustion or to output corresponding information in the form of a temperature signal by detecting the temperature of the combustion waste gases. If a fording state occurs, during which water enters the exhaust system 34 due to a rising water level especially with the combustion operation running and it also reaches the flame sensor 52, this is spontaneously cooled by the water. This causes the temperature signal sent by the flame sensor 52 to indicate an abrupt temperature drop, which indicates the occurrence of a fording state. By analyzing the temperature signal, for example, in the actuating device 40, especially the gradient of the temperature signal over time, the occurrence of a fording state can be inferred if this gradient drops below a predefined negative threshold value based on the great drop in temperature and hence in the temperature signal, whereupon the actuating device 40 can then put the heater 16 into the fording operation in the above-described manner.

Even if the heater 16 was not in the combustion operation and the flame sensor 52 sends a temperature signal that reflects a temperature that is present at this time in the area of the heater 16 and may be close, for example, to the ambient temperature or somewhat above the ambient temperature due to the positioning in the engine compartment 14, the entry of water into the exhaust system 34 leads, when this water reaches the flame sensor 52, based on the circumstance that this water has, in general, a temperature different from the ambient temperature, to a correspondingly abrupt change in the temperature detected by the flame sensor 52 and to a correspondingly great drop of the temperature signal, which drop can be detected by analyzing the temperature gradient in the above-described manner and can be used as an indicator of the occurrence of a fording state.

In its front area 14 and in its rear area 28, for example, in the area of a front spoiler or of a rear spoiler, the vehicle 12 shown in FIG. 1 further has a water level sensor 54, 56 each, which provides a respective water level sensor 46 or is used as such. If the vehicle 12 is moving forward or backward into water on a downward sloping terrain, the vehicle will first come into contact with water with the areas in which the water level sensors 54, 56 are arranged, and a contact of the wheels of the vehicle with water, which contact was already present before, is left out of consideration. The water level sensors 54, 56, which send a corresponding signal on contact with water and which may equally be configured with a float, as temperature sensors or as moisture sensors, enter corresponding sensor signals into a control device 58 of the vehicle 12. This control device 58 can provide fording state information on the basis of the signals sent by the water level sensors 54, 56 and feed them into a vehicle data bus system 60. Different systems of the vehicle 12 can access this information via the vehicle data bus system 60, for example, in order to close ventilating valves in the presence of this information, to close the windows and the like, in order to prevent water from entering the interior of the vehicle. The actuating device 40 may also be linked to the vehicle data bus system 60 for the data exchange and hence access this information indicating the occurrence of a fording state in the vehicle data bus system 60 and correspondingly put the heater 16 into the fording operation in the presence of this information.

The control device 58 thus provides the fording state information generation device 42 or a part thereof. The sensor signals of the water level sensors 54, 56 provide the essential basis for the information fed by the control device 58 into the vehicle data bus system 60. Thus, fording state information can be provided directly in the sense of the present invention by such a sensor signal, which triggers corresponding actuating steps, for example, in the actuating device 40, but it may also be provided by information provided, for example, in the actuating device 40 or in the control device 58 by an analysis of a sensor signal of a sensor, which also acts as a fording state sensor or acts exclusively as a fording state sensor.

A back pressure, which can prevent water from entering into the area of the burner area 18, is built up in the vehicle heating system 10 according to the present invention and in the process for operating same due to the combustion air blower 20 being actuated in the fording operation to feed combustion air or generally air through the heater 16 and hence also through the exhaust system 34 thereof. The risk that water could also enter the combustion air blower 20 via the combustion air inlet area 22 and hence the heater 16 via this combustion air blower is therefore ruled out, in general, because, as is schematically suggested in FIG. 1, the combustion air inlet area 22 is positioned markedly higher in a vertical direction H, which generally corresponds to a vertical direction, than the waste gas outlet area 32 of the heater 16 or the exhaust gas outlet area 38 of the exhaust system 34, which outlet area may be positioned, for example, at a height level corresponding to the level of the underbody 48. For example, the combustion air inlet area 22 may be positioned in the vertical direction H such that it is located above a maximum expectable water level for an allowable fording operation of the vehicle 12.

While specific embodiments of the invention have been shown and described in detail to illustrate the application of the principles of the invention, it will be understood that the invention may be embodied otherwise without departing from such principles.

What is claimed is:

1. A vehicle heating system comprising:
a fuel-operated heater comprising a burner area and a combustion air blower for feeding combustion air to the burner area;
a fuel pump for feeding fuel to the burner area; and
an actuating device for actuating the combustion air blower and for actuating the fuel pump, the actuating device being configured to actuate the combustion air blower and the fuel pump to carry out a fording operation upon receipt of fording state information.

2. A vehicle heating system in accordance with claim 1, wherein:
the actuating device is configured to actuate the combustion air blower to operate at a fording operation speed and to put the fuel pump out of operation or to keep the fuel pump out of operation to carry out the fording operation; or
the actuating device is configured to actuate the combustion air blower to operate at a fording operation feed rate and to put the fuel pump out of operation or to keep the fuel pump out of operation to carry out the fording operation; or
the actuating device is configured to actuate the combustion air blower to operate at a fording operation speed and to actuate the combustion air blower to operate at a fording operation feed rate and to put the fuel pump out of operation or to keep the fuel pump out of operation to carry out the fording operation.

3. A vehicle heating system in accordance with claim 1, further comprising at least one fording state information generation device for generating and entering the fording state information into the actuating device.

4. A vehicle heating system in accordance with claim 3, wherein the fording state information generation device comprises at least one fording state sensor.

5. A vehicle heating system in accordance with claim 4, wherein the at least one fording state sensor comprises a water level sensor.

6. A vehicle heating system in accordance with claim 5, wherein:
the at least one water level sensor is arranged in an area of an exhaust gas outlet area of an exhaust system associated with the heater; or
the at least one water level sensor is arranged in a front area of a vehicle; or
the at least one water level sensor is arranged in a rear area of a vehicle; or
the at least one water level sensor comprises one or more sensor that is any of arranged in an area of an exhaust gas outlet area of an exhaust system associated with the heater, arranged in a front area of a vehicle and arranged in a rear area of the vehicle.

7. A vehicle heating system in accordance with claim 4, wherein the at least one fording state sensor comprises a temperature sensor.

8. A vehicle heating system in accordance with claim 7, wherein:
the temperature sensor is arranged in a waste gas outlet area of the heater; or
the temperature sensor is arranged in an area of an exhaust gas outlet area of an exhaust system of the heater; or
the temperature sensor is arranged in a waste gas outlet area of the heater and arranged in an area of an exhaust gas outlet area of an exhaust system of the heater.

9. A vehicle heating system in accordance with claim 7, wherein the temperature sensor is configured as a flame sensor of the heater.

10. A vehicle heating system in accordance with claim 3, wherein the fording state information generation device comprises at least one fording state switch that can be actuated by a human operator.

11. A vehicle heating system in accordance with claim 3, wherein the fording state information generation device comprises a vehicle control device feeding fording state information into a vehicle data bus system.

12. A vehicle heating system in accordance with claim 3, wherein:
fording state information indicating an existing or planned fording state of a vehicle is generated and is entered into the actuating device; and
upon receipt of the fording state information or upon processing of the fording state information in the actuating device or upon receipt of the fording state information and upon processing of the fording state information in the actuating device, the actuating device actuates the combustion air blower and the fuel pump to carry out a fording operation.

13. A process for operating a vehicle heating system, the process comprising the steps of:
providing the vehicle heating system with a fuel-operated heater comprising a burner area and a combustion air blower for feeding combustion air to the burner area, a fuel pump for feeding fuel to the burner area and an actuating device for actuating the air blower and the fuel pump;
generating fording state information indicating an existing or planned fording state of a vehicle and entering the fording state information into the actuating device; and
upon receipt of the fording state information or upon processing of the fording state information in the actuating device or upon receipt of the fording state information and upon processing of the fording state information in the actuating device, with the actuating device, actuating the combustion air blower and the fuel pump to carry out a fording operation.

14. A process in accordance with claim 13, wherein:
the combustion air blower is operated, during the step of actuating the combustion air blower and the fuel pump, at a fording operation speed and the fuel pump is put out of operation or is kept out of operation to carry out the fording operation; or
the combustion air blower is operated, during the step of actuating the combustion air blower and the fuel pump, at a fording operation feed rate and the fuel pump is put out of operation or is kept out of operation to carry out the fording operation; or
the combustion air blower is operated, during the step of actuating the combustion air blower and the fuel pump, at a fording operation speed and at a fording operation feed rate and the fuel pump is put out of operation or is kept out of operation to carry out the fording operation.

15. A process in accordance with claim 13, wherein the fording state information is generated by actuating a fording state switch.

16. A process in accordance with claim 13, wherein the fording state information is generated by at least one water level sensor detecting a water level in the area of a vehicle.

17. A process in accordance with claim 13, wherein the fording state information is generated by a flame sensor of the heater, which flame sensor is configured as a temperature sensor.

18. A process in accordance with claim 17, wherein a change over time, in an output signal reflecting a temperature in the area of the flame sensor, is analyzed such that the presence of a fording state is detected when a gradient of the output signal drops below a predefined negative threshold value.

19. A vehicle comprising vehicle heating system, the vehicle heating system comprising:
a fuel-operated heater comprising a burner area and a combustion air blower for feeding combustion air to the burner area;
a fuel pump for feeding fuel to the burner area; and
an actuating device for actuating the combustion air blower and for actuating the fuel pump, the actuating device being configured to actuate the combustion air blower and the fuel pump to carry out a fording operation upon receipt of fording state information.

20. A vehicle in accordance with claim 19, further comprising a heater exhaust system associated with the heater, wherein a combustion air inlet area of the combustion air blower is arranged above the waste gas outlet area of the burner area or above an exhaust gas outlet area of an exhaust system associated with the heater in a vertical direction.
